(19) United States
(12) Patent Application Publication
(10) Pub. No.: US 2011/0262652 A1
(43) Pub. Date: Oct. 27, 2011

(54) IMPRINT APPARATUS AND METHOD OF MANUFACTURING COMMODITY

(75) Inventor: Koji DOKAI, Utsunomiya-shi (JP)

(73) Assignee: CANON KABUSHIKI KAISHA, Tokyo (JP)

(21) Appl. No.: 13/093,327

(22) Filed: Apr. 25, 2011

(30) Foreign Application Priority Data
Apr. 26, 2010 (JP) 2010-101441

(51) Int. Cl. B05D 3/06; B05C 11/00

(52) U.S. Cl. 427/510; 118/663

(57) ABSTRACT

The present invention provides an imprint apparatus which performs imprint processing of curing a resin on a substrate while pressing a mold against the resin, and transferring a pattern onto the substrate by separating the mold from the cured resin, the apparatus including a holding unit including a holding surface which comes into contact with the mold and configured to hold the mold on the holding surface, a measurement unit configured to measure a position of the mold on the holding surface, and a processing unit configured to perform preparation processing including at least one pressing operation of stabilizing the position of the mold on the holding surface by pressing the mold against the holding surface before the imprint processing.

### BACKGROUND OF THE INVENTION

1. Field of the Invention

The present invention relates to an imprint apparatus and a method of manufacturing a commodity.

2. Description of the Related Art

An imprint technique capable of forming fine patterns has received a great deal of attention as a technique for manufacturing various devices (semiconductor devices such as ICs and LSIs, liquid crystal devices, imaging devices such as CCDs, and magnetic heads). The imprint technique transfers, by curing a resin, a fine pattern formed on an original (mold) onto a substrate such as a silicon wafer or a glass plate while pressing the original against the resin on the substrate.

The imprint technique includes several resin curing methods. A photo-curing method is known as one of such resin curing methods. The photo-curing method irradiates an ultraviolet-curing resin with ultraviolet light, while pressing a transparent mold against the resin, to expose the resin to the light and cure it, and then separates (releases) the mold. The imprint technique based on the photo-curing method is suited to the manufacture of devices because it allows relatively easy temperature control and observation of alignment marks on a substrate via a transparent mold.

In an imprint apparatus using such an imprint technique, if the attitude of a mold changes when the mold is pressed against the resin on a substrate, the pattern transferred onto the substrate shifts from a target position. Under the circumstance, U.S. Pat. No. 6,986,975 discloses a technique of adjusting the positional relationship between a mold and a substrate for each shot region on the substrate before the mold is pressed against the resin on the substrate.

According to the conventional technique, however, the impressing force generated when a mold is pressed against the resin on a substrate sometimes shifts the position of the mold on a mold stage. Especially when the mold is not in uniform contact with the holding surface of the mold stage which comes into contact with the mold, the position of the mold on the holding surface of the mold stage changes as the mold is pressed against the resin on the substrate. As a consequence, the pattern transferred onto the substrate shifts from the target position, resulting in a defective pattern portion.

### SUMMARY OF THE INVENTION

The present invention provides a technique capable of transferring the pattern of a mold to a target position on a substrate.

According to one aspect of the present invention, there is provided an imprint apparatus which performs imprint processing of curing a resin on a substrate while pressing a mold against the resin, and transferring a pattern onto the substrate by separating the mold from the cured resin, the apparatus including a holding unit including a holding surface which comes into contact with the mold and configured to hold the mold on the holding surface, a measurement unit configured to measure a position of the mold on the holding surface, and a processing unit configured to perform preparation processing including at least one pressing operation of stabilizing the position of the mold on the holding surface by pressing the mold against the holding surface before the imprint processing, wherein the processing unit repeats the pressing operation in the preparation processing if an amount of change in the position of the mold after the pressing operation, which is measured by the measurement unit, relative to the position of the mold before the pressing operation exceeds a first threshold, and terminates the preparation processing if the amount of change is not more than the first threshold.

Further aspects of the present invention will become apparent from the following description of exemplary embodiments with reference to the attached drawings.

### BRIEF DESCRIPTION OF THE DRAWINGS

FIG. 1 is a view showing the arrangement of an imprint apparatus as one aspect of the present invention.

FIG. 2 is a schematic plan view showing the arrangement of the imprint apparatus shown in FIG. 1 around a mold.

FIGS. 3A and 3B are views for explaining that a pattern transferred onto a substrate shifts from a target position when the holding surface of a mold stage is not in uniform contact with the mold.

FIGS. 4A and 4B are views for explaining that a pattern transferred onto a substrate shifts from a target position when the mold deforms.

FIGS. 5A and 5B are graphs showing the relationship between the number of times a mold is pressed against a resin (the number of times of impression) and the amount of change in the position of the mold on the holding surface of the mold stage.

FIG. 6 is a flowchart for explaining the operation of the imprint apparatus shown in FIG. 1.

FIG. 7 is a view showing the positional relationship between the mark formed on a substrate and the pattern of a mold which is transferred onto a shot region on the substrate in preparation processing.

FIGS. 8A and 8B are views for explaining the detection of a mark formed on a substrate with the scope of the imprint apparatus shown in FIG. 1.

FIGS. 9A and 9B are views for explaining that defective pattern portions are generated when a surfactant does not sufficiently adhere to the pattern surface of a mold.

FIG. 10 is a graph showing the relationship between the number of times a mold is pressed against a resin containing a surfactant (the number of times of impression) and the separating force required to separate the mold from the cured resin.

FIG. 11 is a flowchart for explaining the operation of the imprint apparatus shown in FIG. 1.

FIGS. 12A and 12B are graphs showing the relationship between the number of times force is applied to a side surface of a mold (the number of times of adjustment) and the amount of change in the position of the mold on the holding surface of the mold stage.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

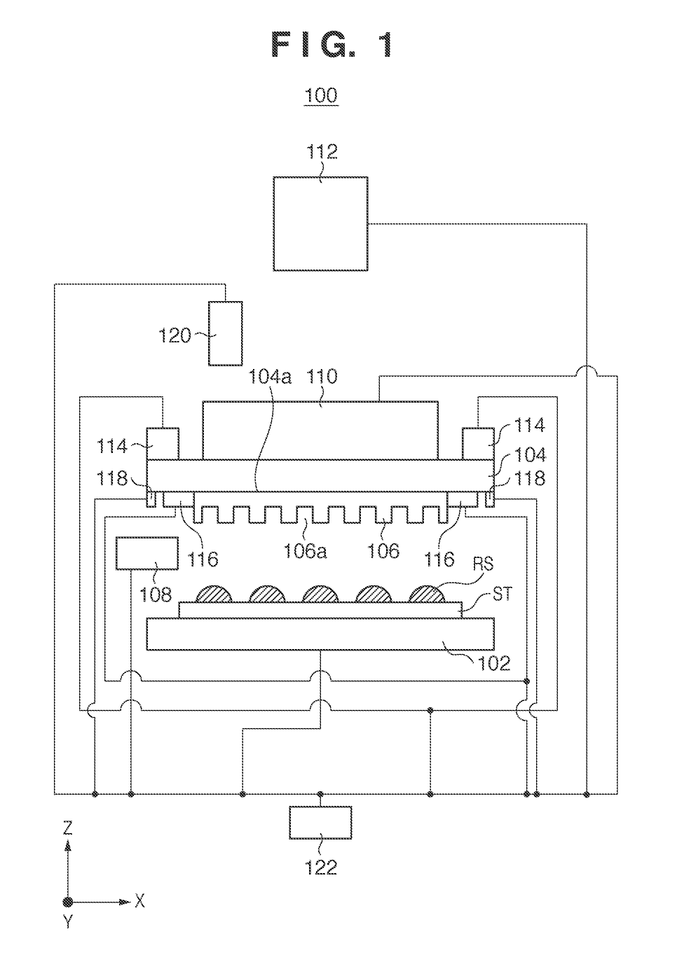

FIG. 1 is a view showing the arrangement of an imprint apparatus 100 as one aspect of the present invention. The imprint apparatus 100 performs the imprint processing of transferring (forming) a pattern onto a substrate by curing a resin on the substrate while pressing a mold against the resin and separating (releasing) the mold from the cured resin.

The imprint apparatus 100 includes a substrate stage 102, a mold stage 104 to hold a mold 106, a supply unit 108, a driving unit 110, a light source 112, a detection unit 114, adjustment units 116, a measurement unit 118, a scope 120, and a control unit 122.

The substrate stage 102 holds a substrate ST such as a silicon wafer or a glass plate through a substrate chuck, and positions the substrate ST at a predetermined position by driving it.

The mold stage 104 functions as a holding unit to hold the mold 106 through a holding surface 104a which comes into contact with the mold 106. The mold 106 is made of a material which transmits light from the light source 112, and has a pattern surface 106a on which a pattern (indented pattern) to be transferred onto the substrate ST is formed.

The supply unit 108 includes a plurality of dispensers to discharge a resin RS in the form of droplets, and supplies (applies) the resin RS onto a substrate (a shot region onto which a pattern is to be transferred). More specifically, driving (scan driving or step driving) the substrate stage 102 while discharging the resin RS from the dispensers constituting the supply unit 108 can apply the resin RS onto the substrate ST. Note that the resin RS is a photo-curing resin containing a release agent such as a surfactant in this embodiment.

The driving unit 110 includes an actuator constituted by an air cylinder, a linear motor, and the like, and drives the mold 106 (the mold stage 104 holding the mold 106). The driving unit 110 drives the mold 106 downward to press the mold 106 against the resin RS supplied onto the substrate ST. The driving unit 110 also drives the mold 106 upward to separate the mold 106 from the cured resin RS on the substrate ST.

The light source 112 cures the resin RS by irradiating the resin RS with ultraviolet light while the mold 106 is pressed against the resin RS supplied onto the substrate ST (that is, through the mold 106). In other words, the light source 112 functions as a curing unit to cure the resin RS supplied onto the substrate ST.

The detection unit 114 detects the impressing force generated when the mold 106 is pressed against the resin RS supplied onto the substrate ST and the separating force required to separate the mold 106 from the cured resin RS on the substrate ST. In this embodiment, the detection unit 114 is constituted by load cells arranged on the mold stage 104. However, the detection unit to be used is not limited to this. For example, the detection unit 114 may be formed by a voltmeter which detects the voltage applied to the substrate stage 102 to separate the mold 106, and may estimate (detect) a separating force from the voltage detected by the voltmeter.

Each adjustment unit 116 is constituted by chucking members to chuck a side surface of the mold 106 and an actuator to press or pull the chucking member, and has a function of deforming the mold 106 held by the mold stage 104. The adjustment units 116 adjust the magnification, distortion, and the like of the mold 106 by applying force to a side surface of the mold 106 in the imprint processing of transferring the pattern of the mold 106 onto the substrate ST.

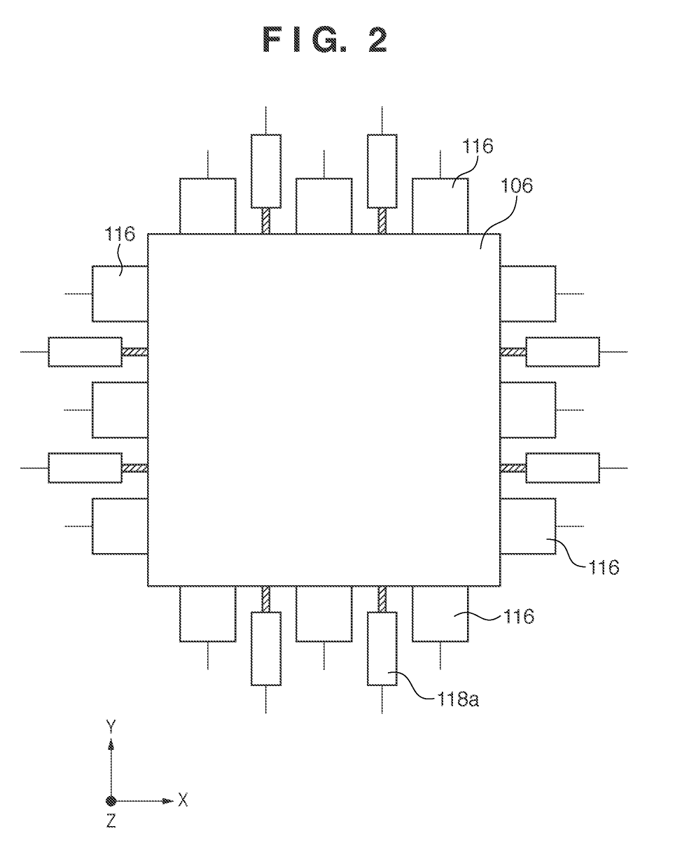

The measurement unit 118 measures the position of the mold 106 on the holding surface 104a of the mold stage 104. In this embodiment, as shown in FIG. 2, the measurement unit 118 is constituted by a plurality of interferometers 118a arranged around the mold 106. However, the measurement unit to be used is not limited to this. For example, the measurement unit 118 may be formed by a capacitance sensor, an encoder, or the like. In this case, FIG. 2 is a schematic plan view showing an arrangement around the mold 106.

The scope 120 detects a mark formed on the substrate ST or a mark formed on the mold 106. The scope 120 can also detect a reference mark or the like formed on the substrate stage 102. Note that the scope 120 also functions as a detection optical system to detect the pattern of the mold 106 which is transferred onto the substrate ST as well as the mark formed on the substrate ST, as will be described later.

The control unit 122 includes a CPU and a memory, and functions as a processing unit to perform each kind of processing in the imprint apparatus 100 (that is, makes the imprint apparatus 100 operate). For example, the control unit 122 controls the respective units of the imprint apparatus 100 to perform preparation processing including at least one pressing operation of stabilizing the position of the mold 106 on the holding surface 104a of the mold stage 104 by pressing the mold 106 against the holding surface 104a. In addition, the control unit 122 controls the respective units of the imprint apparatus 100 to perform adhesion processing including at least one adhesion operation of causing the surfactant contained in the resin RS to adhere to the pattern surface 106a of the mold 106. In addition, the control unit 122 controls the respective units of the imprint apparatus 100 to perform the imprint processing of transferring the pattern of the mold 106 onto the substrate ST after preparation processing and adhesion processing.

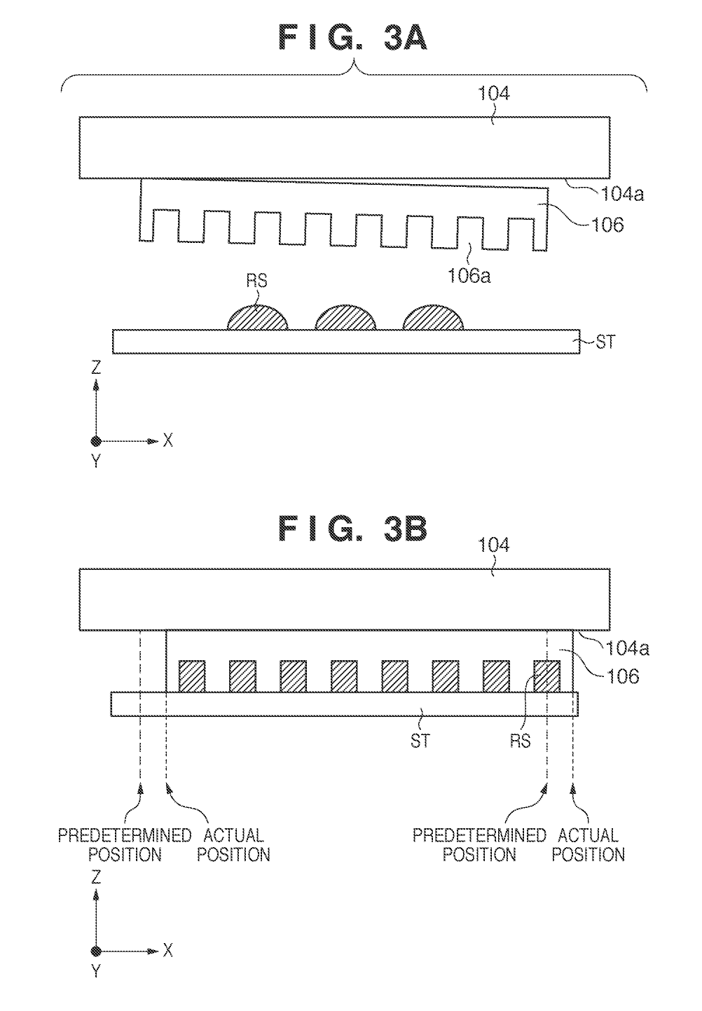

The necessity to stabilize the position of the mold 106 on the holding surface 104a of the mold stage 104 (that is, preparation operation) will be described below. Consider, for example, a case in which when the mold stage 104 holds the mold 106, the holding surface 104a of the mold stage 104 is not in uniform contact with the mold 106, as shown in FIG. 3A. In this case, when the mold 106 is pressed against the resin RS on the substrate ST, the position (actual position) of the mold 106 on the holding surface 104a shifts from a predetermined position due to the impressing force generated when the mold 106 is pressed against the resin RS, as shown in FIG. 3B. As a consequence, the pattern transferred onto the substrate ST shifts from the target position to generate a defective pattern portion. Although FIG. 3B shows the case in which the position of the mold 106 shifts in the X-axis direction, the pattern transferred onto the substrate ST shifts from the target position in the same manner even when the position of the mold 106 shifts in the Y-axis direction or rotates in the X-Y plane.

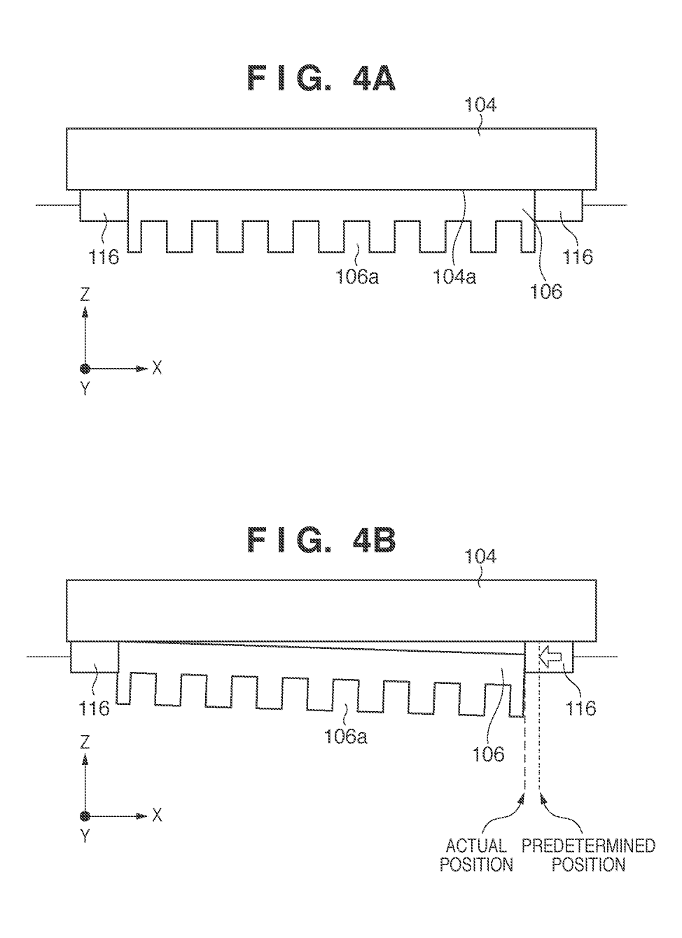

In imprint processing, when the mold 106 is aligned with the substrate ST, the adjustment units 116 deform the mold 106 (that is, adjust the magnification or distortion of the mold 106) in accordance with a factor such as a process. In this case, as shown in FIGS. 4A and 4B, even if the holding surface 104a of the mold stage 104 is in uniform contact with the mold 106 before the deformation of the mold 106, when the mold 106 deforms, the holding surface 104a and the mold 106 sometime do not come into uniform contact with each other. Therefore, as described above, the impressing force generated when the mold 106 is pressed against the holding surface 104a causes the position (actual position) of the mold 106 on the holding surface 104a to shift from a predetermined position. As a consequence, the pattern transferred onto the substrate ST shifts from the target position. Note that FIG. 4A shows a state in which the holding surface 104a of the mold stage 104 is in uniform contact with the mold 106 before the mold 106 deforms. FIG. 4B shows a state in which the holding surface 104a of the mold stage 104 is not in uniform contact with the mold 106 when the mold 106 deforms from the state shown in FIG. 4A due to the force applied to a side surface of the mold 106. FIGS. 4A and 4B show a case in which the position of the mold 106 shifts in the X-axis direction. However, when the position of the mold 106 shifts in the Y-axis direction or rotates in the X-Y plane, the pattern transferred onto the substrate ST shifts from the target position in the same manner.

In order to transfer the pattern of the mold 106 to the target position on the substrate, it is necessary to make the holding surface 104a of the mold stage 104 come into uniform contact with the mold 106 and prevent the position of the mold 106 from shifting due to the impressing force generated when the mold 106 is pressed against the holding surface 104a.

This embodiment therefore performs preparation processing including pressing operation to stabilize the position of the mold 106 on the holding surface 104a by pressing the mold 106 against the holding surface 104a of the mold stage 104 before imprint processing (normal process). The operation of pressing the mold 106 against the holding surface 104a of the mold stage 104 may be, for example, the operation of pressing the mold 106 against the resin RS supplied onto the substrate ST.

In preparation processing, first of all, when the mold 106 is loaded into the imprint apparatus 100 and held on the holding surface 104a of the mold stage 104, the measurement unit 118 measures the position of the mold 106 on the holding surface 104a. The mold 106 is pressed against the resin RS supplied onto the substrate ST, and the resin RS is cured. The mold 106 is separated from the cured resin RS. The measurement unit 118 then measures the position of the mold 106 on the holding surface 104a. This apparatus obtains an amount of change Ci in the position of the mold 106 after the mold 106 is pressed against the resin RS (that is, after pressing operation is performed) relative to the position of the mold 106 before the mold 106 is pressed against the resin RS (that is, before pressing operation is performed).

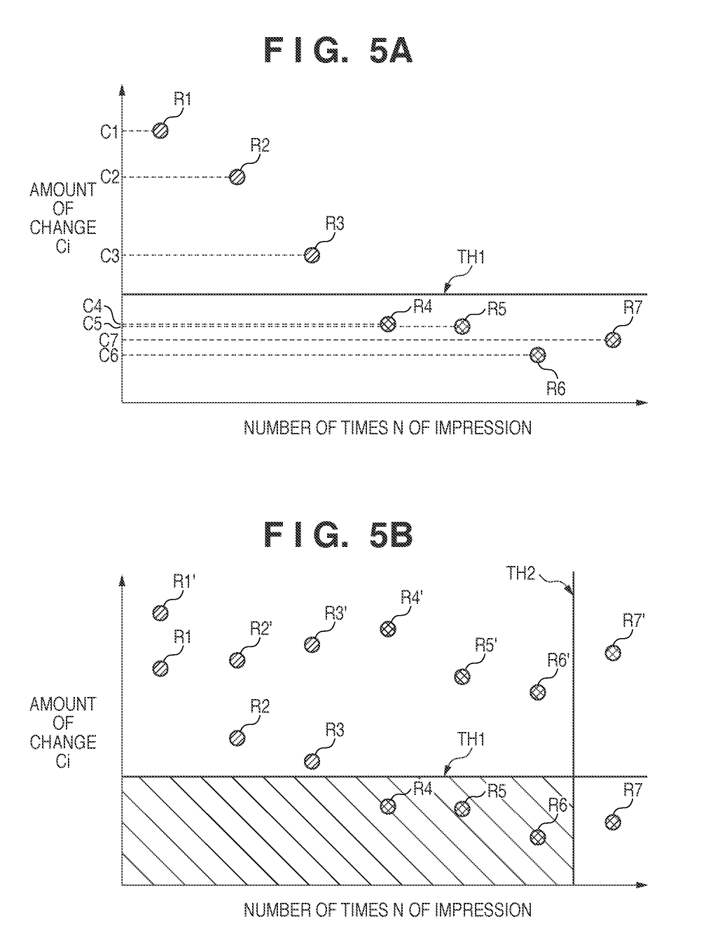

FIG. 5A is a graph showing the relationship between a number of times (a number of times of impression) N the mold 106 is pressed against the resin RS and the amount of change Ci in the position of the mold 106 on the holding surface 104a of the mold stage 104. An amount of change C1 corresponding to a plot R1 indicates the amount of change in the position of the mold 106 when the mold 106 is pressed against the resin RS once (N=1) relative to the position of the mold 106 when the mold 106 has never been pressed against the resin RS (N=0). In this case, since the holding surface 104a of the mold stage 104 is not in uniform contact with the mold 106, the amount of change C1 is larger than a threshold (first threshold) TH1. Note that the threshold TH1 is set to a value equal to or less than the maximum value of the amount of change Ci which is allowed for the transfer of a pattern to a target position on the substrate (that is, a value including a predetermined margin relative to the maximum value), and is an experimentally or theoretically derived value.

Pressing the mold 106 against the resin RS supplied onto the substrate ST repeatedly (a plurality of number of times) will gradually bring the mold 106 into uniform contact with the holding surface 104a of the mold stage 104. Therefore, as indicated by plots R2, R3, and R4, the amount of change Ci gradually decreases to amounts of change C2, C3, and C4. When the mold 106 comes into uniform contact with the holding surface 104a of the mold stage 104, the amount of change Ci converges (becomes values near amounts of change C5, C6, and C7), as indicated by plots R5, R6, and R7.

As indicated by inequality (1), it is thought that when the amount of change Ci is equal to or less than the threshold TH1 (the amounts of change C4 to C7), the holding surface 104a of the mold stage 104 is in uniform contact with the mold 106. It is therefore possible to transfer the pattern of the mold 106 to the target position on the substrate by reducing the positional shift of the mold 106 due to the impressing force generated when the mold 106 is pressed against the resin RS (that is, making the positional shift converge to an allowable value).

Ci≦TH1 (1)

Note that in preparation processing, even if the number of times the mold 106 is pressed against the holding surface 104a of the mold stage 104, that is, the mold 106 is pressed against the resin RS, becomes equal to or more than a specified number of times, the amount of change Ci may not become equal to or less than the threshold TH1. FIG. 5B is a view showing the relationship between the number of times (the number of times of impression) N the mold 106 is pressed against the resin RS and the amount of change Ci in the position of the mold 106 on the holding surface 104a of the mold stage 104. Referring to FIG. 5B, the plots R1 to R7 indicate that the amount of change Ci becomes equal to or less than TH1 before the number of times N of impression of the mold 106 reaches a specified number of times TH2. In contrast, plots R1′ to R7′ indicate that even when the number of times N of impression becomes equal to or more than the specified number of times TH2, the amount of change Ci does not become equal to or less than the threshold TH1. In this case, since the mold stage 104 and the mold 106 may not be in a normal state, it is necessary to terminate the preparation processing, inspect the mold stage 104 and the mold 106, and replace the mold stage 104 and the mold 106 in accordance with the inspection results. The apparatus then performs imprint processing upon confirming that the relationship between the amount of change Ci and the threshold TH1 and the relationship between the number of times N of impression of the mold 106 and the specified number of times TH2 satisfy inequalities (2):

Ci≦TH1 and N≦TH2 (2)

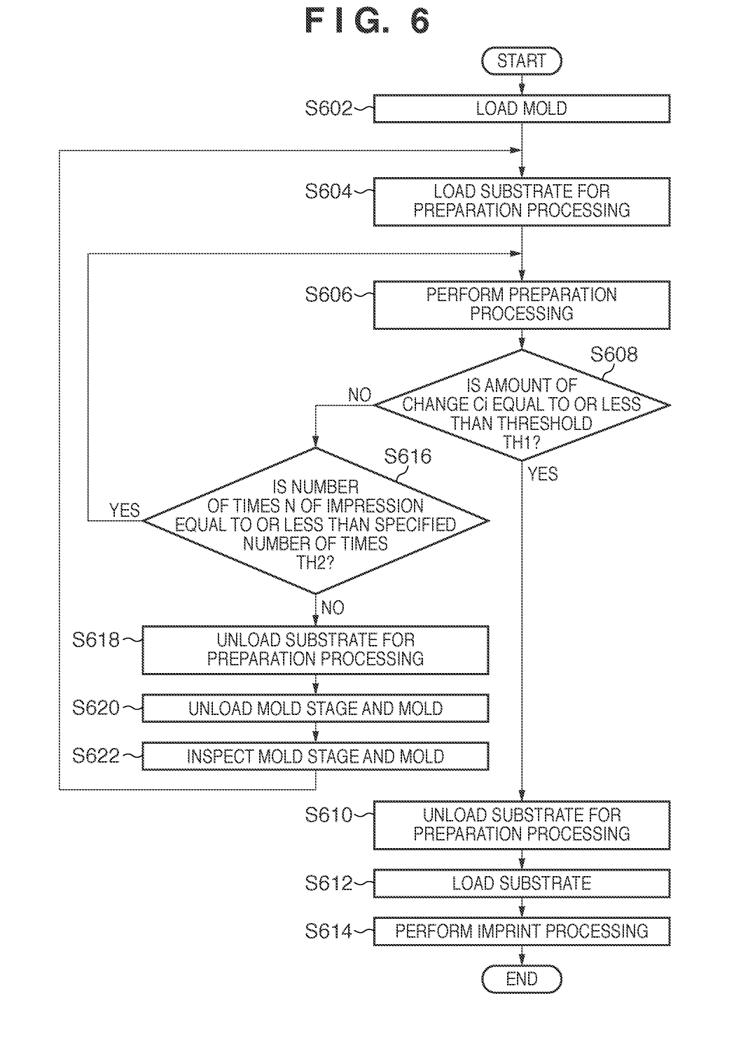

The operation of the imprint apparatus 100 will be described below with reference to FIG. 6, focusing on preparation processing to be performed before imprint processing. Note that the control unit 122 comprehensively controls the respective units of the imprint apparatus 100 to perform the operation of the imprint apparatus 100 shown in FIG. 6.

In step S602, the operator loads the mold 106 into the imprint apparatus 100, and makes the mold stage 104 (holding surface 104a) hold the mold 106.

In step S604, the operator loads, into the imprint apparatus 100, a substrate for preparation processing, which is different from the substrate ST for which imprint processing is to be performed, and makes the substrate stage 102 hold the substrate for preparation processing.

In step S606, the apparatus performs preparation processing including the operation of stabilizing the position of the mold 106 on the holding surface 104a of the mold stage 104 by pressing the mold 106 against the holding surface 104a. More specifically, first of all, the supply unit 108 supplies the resin RS to a plurality of regions (corresponding to shot regions) on the substrate for preparation processing. Subsequently, the substrate stage 102 drives the substrate for preparation operation to place a region (target region) on the substrate for preparation operation against which the mold 106 is to be pressed to a position corresponding to the mold 106 (pattern surface 106a). The measurement unit 118 then measures the position of the mold 106 on the holding surface 104a of the mold stage 104. The driving unit 110 drives the mold 106 downward to press the mold 106 against the resin RS supplied onto the substrate for preparation operation and press the mold 106 against the holding surface 104a of the mold stage 104. While the mold 106 is pressed against the resin RS, the light source 112 irradiates the resin RS with ultraviolet light to cure the resin RS. The driving unit 110 then drives the mold 106 upward to separate the mold 106 from the cured resin RS on the substrate for preparation operation. The measurement unit 118 measures the position of the mold 106 on the holding surface 104a of the mold stage 104. The apparatus then obtains the amount of change Ci in the position of the mold 106 after pressing operation for the mold 106 relative to the position of the mold 106 before pressing operation. Pressing the mold 106 against the resin RS supplied onto the substrate in preparation operation brings the mold 106 into uniform contact with the holding surface 104a of the mold stage 104.

In step S608, it is determined whether the amount of change Ci obtained in the preparation processing in step S606 is equal to or less than a threshold (that is, the threshold TH1 or less). If the amount of change Ci is equal to or less than the threshold TH1, since it is thought that the holding surface 104a of the mold stage 104 is in uniform contact with the mold 106, the process shifts to step S610 to unload the substrate for preparation processing from the imprint apparatus 100. The apparatus then terminates the preparation processing. If the amount of change Ci is not equal to or less than the threshold TH1, that is, is larger than the threshold TH1, since it is thought that the holding surface 104a of the mold stage 104 is not in uniform contact with the mold 106, the process shifts to step S616.

In step S612, the operator loads the substrate ST for which imprint processing is to be performed into the imprint apparatus 100, and makes the substrate stage 102 hold the substrate ST.

In step S614, the apparatus performs the imprint processing of transferring the pattern of the mold 106 onto the substrate ST loaded in step S612, and terminates the operation. Note that since the concrete imprint processing is the same as the above preparation processing except that a substrate for preparation processing replaces the substrate ST, a detailed description of the processing will be omitted. Note, however, that global alignment is performed for the adjustment of the positional relationship between the mold 106 and the substrate ST, that is, alignment between the mold 106 and the substrate ST. In other words, this embodiment does not perform alignment between the mold 106 and the substrate ST for each shot region. When performing imprint processing, the apparatus may change the attitude of the mold 106 by causing the adjustment units 116 to apply force to a side surface of the mold 106. In such a case, it is necessary to suppress the force to be applied to a side surface of the mold 106 to a volume that does not change the position of the mold 106 on the holding surface 104a of the mold stage 104.

In step S616, it is determined whether the number of times (the number of times of impression) N the mold 106 is pressed against the resin RS on the substrate ST in the preparation operation in step S606 is equal to or less than the specified number of times TH2. If the number of times N of impression is equal to or less than the specified number of times TH2, the process shifts to step S606 to repeat the operation of pressing the mold 106 against the holding surface 104a of the mold stage 104 (that is, continuing preparation processing). If the number of times N of impression exceeds the specified number of times TH2, the process shifts to step S618.

In step S618, the operator unloads the substrate for preparation processing from the imprint apparatus 100, and terminates the preparation processing. In step S620, the operator unloads the mold stage 104 and the mold 106 from the imprint apparatus 100.

In step S622, the mold stage 104 and the mold 106 unloaded in step S620 are inspected. Predetermined processing (for example, replacement of the mold stage 104 and mold 106) is performed in accordance with the inspection results on the mold stage 104 and the mold 106. The process then shifts to step S604.

As described above, this embodiment repeats pressing operation in preparation processing when the amount of change Ci in the position of the mold 106 exceeds the threshold TH1, and terminates preparation processing when the amount of change Ci is equal to or less than the threshold TH1. This makes it possible to bring the holding surface 104a of the mold stage 104 into uniform contact with the mold 106 while minimizing the number of times of pressing operation (that is, shortening the time taken for preparation processing). Therefore, the imprint apparatus 100 of this embodiment can reduce the positional shift of the mold 106 due to the impressing force generated when the mold 106 is pressed against the resin RS on the substrate ST, and transfer the pattern of the mold 106 to a target position on the substrate ST. In addition, the imprint apparatus 100 of the embodiment prevents the positional shift of the mold 106 when the mold 106 is pressed against the resin RS, and hence can perform global alignment. This makes it possible to suppress a reduction in throughput (productivity). Note that in this embodiment, if the number of times of pressing operation in preparation processing, that is, the number of times N of impression, exceeds the specified number of times TH2, the apparatus terminates the preparation processing. This can prevent the apparatus from continuing preparation processing when the mold stage 104 (the holding surface 104a) or the mold 106 is not in a normal state and the amount of change Ci does not become equal to or less than the threshold TH1 in spite of an increase in the number of times N of impression.

According to the above description, the apparatus performs preparation processing by using a substrate for preparation processing which is different from the substrate ST for which imprint processing is to be performed. However, it is possible to perform preparation processing by using the substrate ST for which imprint processing is to be performed. In this case, if the amount of change Ci in the position of the mold 106 on the holding surface 104a of the mold stage 104 is equal to or less than the threshold TH1, the control unit 122 determines that the pattern of the mold 106 which has been transferred onto the substrate ST is good. If the amount of change Ci exceeds the threshold TH1, the control unit 122 determines that the pattern of the mold 106 which has been transferred onto the substrate ST is defective. The apparatus then stores, in a storage unit such as a memory, the determination result obtained by determining whether the pattern of the mold 106 which has been transferred onto the substrate ST is good or defective, and uses it in an inspection step as a subsequent step. More specifically, the apparatus can exclude a shot region onto which a pattern determined as a defective pattern has been transferred from the semiconductor manufacturing process. Obviously, it is not necessary to exclude even a shot region onto which a pattern determined as a defective pattern has been transferred, when the inspection result in the inspection step is good. Performing preparation processing using the substrate ST in this manner may incorporate the preparation processing in imprint processing.

In addition, in this embodiment, a resin used in preparation processing may not be the same as that used in the imprint processing of transferring the pattern of the mold. For example, a resin used in imprint processing may not contain any surfactant.

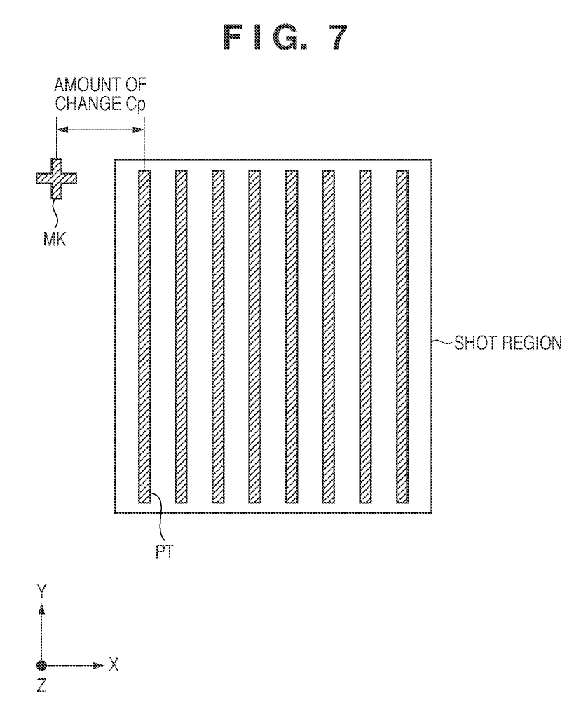

This embodiment has exemplified the case in which the apparatus obtains the amount of change Ci in the position of the mold 106 on the holding surface 104a of the mold stage 104 from the measurement result obtained by the measurement unit 118 (a plurality of interferometers 118a). As shown in FIG. 7, however, it is possible to detect a mark MK formed on a substrate and a pattern PT of the mold 106 which has been transferred onto a shot region on the substrate in preparation processing. Note that in this case, it is necessary to perform pressing operation at least twice, including the first and second pressing operations of pressing the mold 106 against the holding surface 104a of the mold stage 104 (that is, pressing the mold 106 against the resin RS). When the position of the mark MK is set as a reference, an amount of change Cp in the position of the pattern PT transferred by the second pressing operation relative to the position of the pattern PT transferred by the first pressing operation corresponds to the amount of change Ci in the position of the mold 106 on the holding surface 104a. In this case, the apparatus performs imprint processing upon confirming that the relationship between the amount of change Cp and the threshold TH3 and the relationship between the number of times N of impression of the mold 106 and the specified number of times TH2 satisfy

Cp≦TH3 and N≦TH2 (3)

The threshold TH3 is set to a value equal to or less than the maximum value of the amount of change Cp which is allowed for the transfer of a pattern to a target position on a substrate (that is, a value including a predetermined margin relative to the maximum value), and is an experimentally or theoretically derived value.

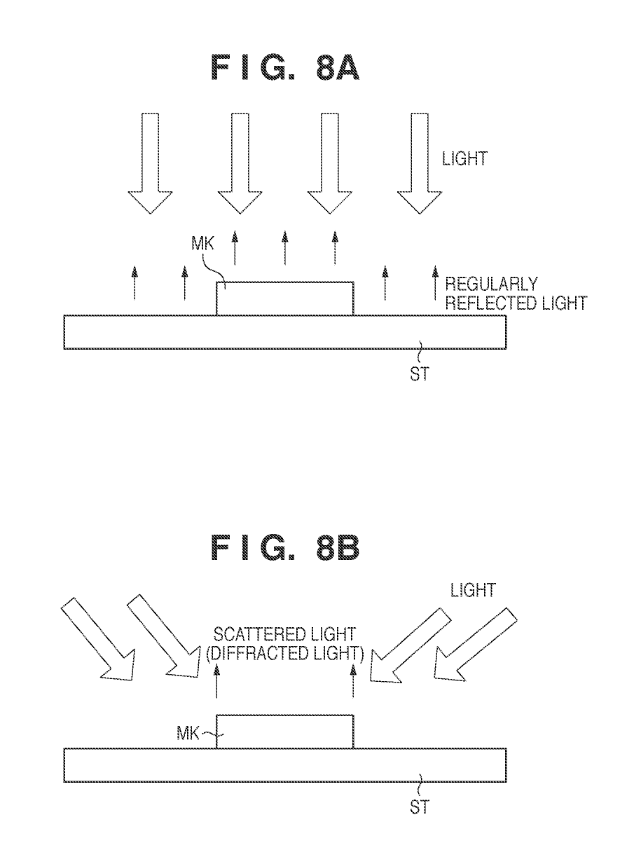

Note that it is possible to detect the mark MK formed on a substrate and the pattern PT of the mold 106 which has been transferred onto a shot region on the substrate in preparation processing by using, for example, the scope 120. More specifically, as shown in FIG. 8A, it is possible to detect the position of the mark MK by vertically irradiating the mark MK on the substrate with light from the light source of the scope 120 and receiving only regularly reflected light (0th-order light) from the mark MK via the light-receiving portion of the scope 120. In addition, as shown in FIG. 8B, it is possible to detect the position of the mark MK by obliquely irradiating the mark MK on a substrate with light and receiving scattered light or diffracted light (nth-order light), of the light reflected by the mark MK, which is reflected by an edge portion.

The pattern PT of the mold 106 which has been transferred onto a shot region on a substrate has an indented shape like the mark MK. Therefore, vertically or obliquely irradiating the pattern PT with light can detect the position of the pattern PT. If, however, the line width of each line constituting the pattern of the mold 106 is at several tens nm level, since the line width is too small, it is difficult to detect only one line of the pattern PT. In this case, a plurality of lines of the pattern PT may be detected as one line.

The imprint apparatus 100 needs to perform adhesion processing including the adhesion operation of causing the surfactant contained in the resin RS to adhere to the pattern surface 106a of the mold 106. A surfactant has not sufficiently adhered to the pattern surface of a mold which has never been used in imprint processing (unused mold) or a mold which has not been used for a period (unused period) longer than a predetermined period. Therefore, the separating force required to separate the mold from the cured resin becomes larger than an estimated value. As a result, the pattern transferred onto the substrate may be peeled off while adhering to the mold and be broken, or the mold or the substrate shifts (or deforms) from a predetermined position.

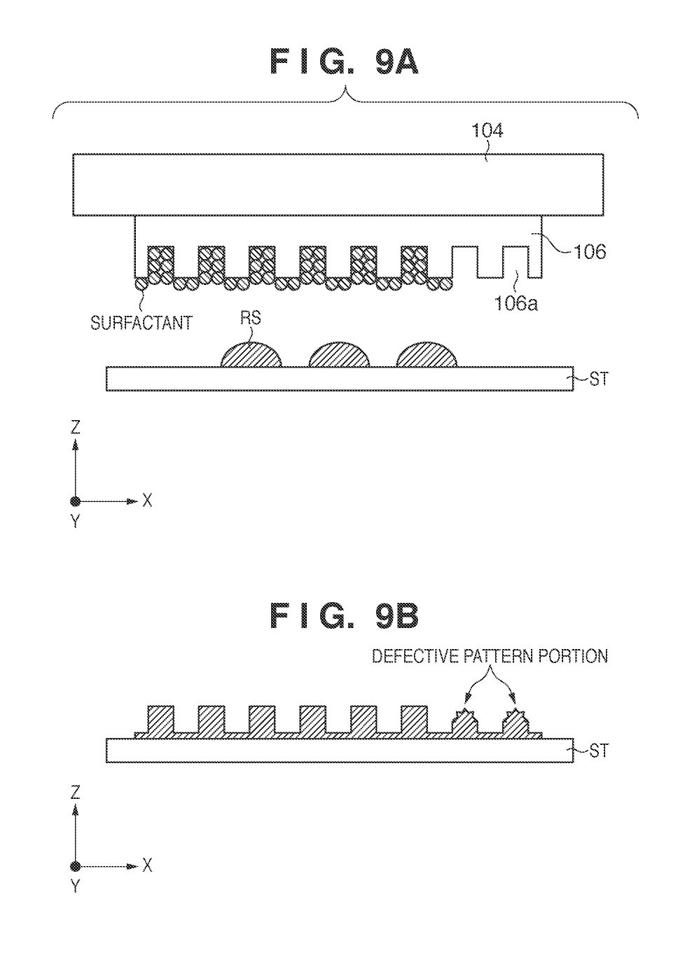

Consider, for example, as shown in FIG. 9A, that a surfactant has not sufficiently adhered to the pattern surface 106a of the mold 106, and has adhered to only part of the pattern surface 106a. In the state shown in FIG. 9A, the mold 106 is pressed against the resin RS on the substrate ST, and the gap between the mold 106 and the substrate ST is filled with the resin RS. When the resin RS is cured and the mold 106 is separated from the resin RS, portions onto which the pattern of the mold 106 has not been transferred (defective pattern portions) are generated on the substrate ST, as shown in FIG. 9B.

In order to accurately transfer the pattern of the mold 106, it is necessary to reduce the separating force required to separate the mold 106 from the cured resin RS by making a surfactant uniformly adhere to the pattern surface 106a of the mold 106. In order to make a surfactant adhere to the pattern surface 106a of the mold 106, it is necessary to coat the pattern surface 106a with the surfactant outside the imprint apparatus 100 or press the resin RS containing the surfactant against the mold 106. When coating the pattern surface 106a with the surfactant outside the imprint apparatus 100, it is necessary to use an apparatus other than the imprint apparatus 100 (processing other than a semiconductor process), and hence it takes much cost and time. This adversely affects the throughput (productivity). In this embodiment, therefore, the surfactant contained in the resin RS adheres to the pattern surface 106a of the mold 106 by pressing the mold 106 against the resin RS containing the surfactant.

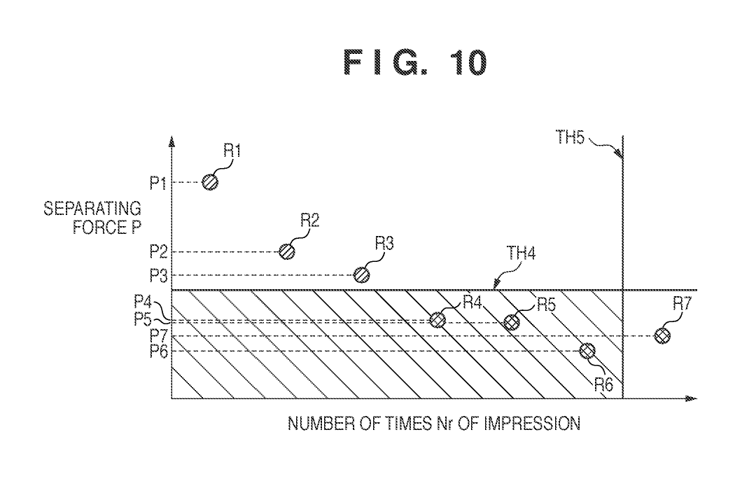

FIG. 10 is a graph showing the relationship between the number of times (the number of times of impression) N the mold is pressed against the resin RS containing a surfactant and a separating force P required to separate the mold 106 from the cured resin RS. Referring to FIG. 10, a separating force P1 corresponding to a plot R1 indicates the separating force required to separate the mold which has never been used in imprint processing or the mold which has not been used for a period longer than a predetermined period from the cured resin RS. In this case, since the surfactant contained in the resin RS has not sufficiently adhered to the pattern surface of the mold, the separating force P1 is larger than a threshold (second threshold) TH4. Note that the threshold TH4 is set to a value equal to or less than the maximum value of the separating force required to transfer the pattern of the mold onto the substrate without breaking (a value including a predetermined margin relative to the maximum value), and is an experimentally or theoretically derived value.

Pressing a mold against the resin RS containing a surfactant repeatedly (a plurality of number of times) makes the surfactant gradually adhere to the pattern surface of the mold. As indicated by the plots R2, R3, and R4, the separating force required to separate the mold from the cured resin RS gradually decreases to the separating forces P2, P3, and P4. When the surfactant uniformly adheres to the pattern surface of the mold, the separating force required to separate the mold from the cured resin RS converges (to values near the separating forces P5, P6, and p7), as indicated by the plots R5, R6, and R7.

In addition, in adhesion processing, even if a mold is pressed against the resin RS containing a surfactant a specified number of times, the separating force required to separate the mold 106 from the cured resin RS may not become equal to or less than the threshold TH4. In such a case, since the resin RS containing the surfactant or the mold 106 may not be a normal state, it is necessary to inspect the resin RS and the mold upon terminating the adhesion processing and to replace the resin RS or the mold as needed. In adhesion processing, therefore, the apparatus checks whether the relationship between the separating force P and the threshold TH4 and the relationship between the number of times N of impression and the specified number of times TH5 satisfy

P≦TH4 and N≦TH5 (4)

The threshold TH4 is set to a value equal to or less than the maximum value of the separating force required to separate the pattern of a mold onto a substrate without breaking it (that is, a value including a predetermined margin relative to the maximum value), and is an experimentally or theoretically derived value. In addition, the specified number of times TH5 may be determined based on the number of times of impression required to transfer the pattern of a mold onto a substrate without breaking it.

Note that when the apparatus is to perform the operation of pressing the mold 106 against the resin RS on the substrate ST as pressing operation in preparation processing, the preparation processing can incorporate adhesion processing including the adhesion operation of making the surfactant contained in the resin RS adhere to the pattern surface 106a of the mold 106. In other words, the operation of pressing the mold 106 against the resin RS on the substrate ST in preparation processing can be made common to the operation of pressing the mold 106 against the resin RS on the substrate ST in adhesion processing.

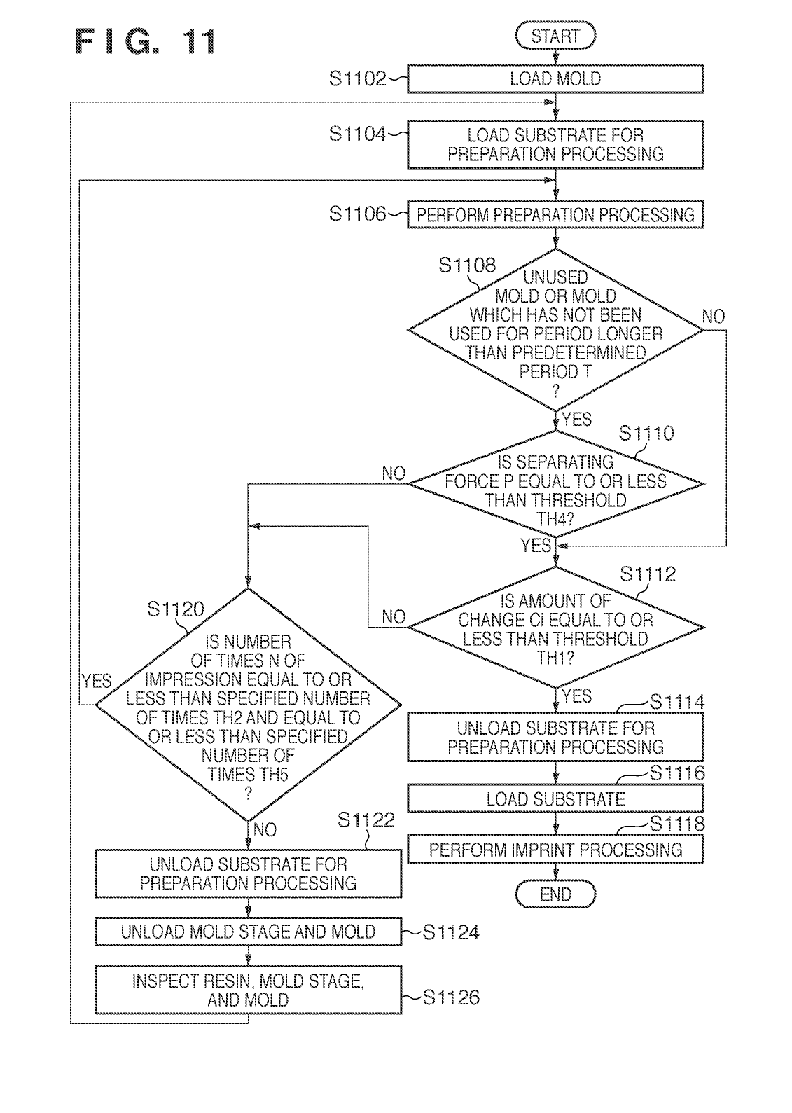

The operation of the imprint apparatus 100 in a case in which preparation processing includes adhesion processing will be described below with reference to FIG. 11. Note that the control unit 122 comprehensively controls the respective units of the imprint apparatus 100 to execute the operation of the imprint apparatus 100 which is shown in FIG. 11.

In step S1102, the operator loads the mold 106 into the imprint apparatus 100, and makes the mold stage 104 (holding surface 104a) hold the mold 106.

In step S1104, the operator loads, into the imprint apparatus 100, a substrate for preparation processing which is different from the substrate ST for which imprint processing is to be performed, and makes the substrate stage 102 hold the substrate for preparation processing.

In step S1106, the apparatus performs preparation processing including the pressing operation for stabilizing the position of the mold 106 on the holding surface 104a of the mold stage 104 and the adhesion operation of causing the surfactant contained in the resin RS to adhere to the pattern surface 106a of the mold 106. More specifically, first of all, the supply unit 108 supplies the resin RS to each of regions (corresponding to shot regions) on the substrate for preparation processing. The substrate stage 102 then drives the substrate for preparation processing to place a region (target region) on the substrate for preparation operation against which the mold 106 is to be pressed to a position corresponding to the mold 106 (pattern surface 106a). The measurement unit 118 measures the position of the mold 106 on the holding surface 104a of the mold stage 104. Subsequently, the driving unit 110 drives the mold 106 downward to press the mold 106 against the resin RS supplied onto the substrate for preparation operation. This allows to simultaneously (commonly) perform the pressing operation of pressing the mold 106 against the holding surface 104a of the mold stage 104 and the adhesion operation of causing the surfactant contained in the resin RS to adhere to the pattern surface 106a of the mold 106. While the mold 106 is pressed against the resin RS, the light source 112 irradiates the resin RS with ultraviolet light to cure the resin RS. The driving unit 110 then drives the mold 106 upward to separate the mold 106 from the cured resin RS on the substrate for preparation operation. In this case, the detection unit 114 detects the separating force P required to separate the mold 106 from the cured resin RS on the substrate for preparation operation. The measurement unit 118 then measures the position of the mold 106 on the holding surface 104a of the mold stage 104. The apparatus obtains the amount of change Ci in the position of the mold 106 after pressing operation relative to the position of the mold 106 before pressing operation. Pressing the mold 106 against the resin RS supplied onto the substrate for preparation operation in preparation processing in this manner will bring the mold 106 into uniform contact with the holding surface 104a of the mold stage 104 and make the surfactant adhere to the pattern surface 106a.

In step S1108, it is determined whether the mold 106 loaded in step S1102 is a mold which has never been used in imprint processing (unused mold) or a mold which has not been used for a period (unused period) longer than a predetermined period T. If the mold 106 is an unused mold or a mold which has not been used for a period longer than the predetermined period T, the process shifts to step S1110. If the mold 106 is not an unused mold or a mold which has not been used for a period longer than the predetermined period T, the process shifts to step S1112.

Note that the predetermined period T is the period between the end of immediately preceding imprint processing using the mold 106 and the start of separating of a surfactant adhering to the pattern surface 106a, and can be experimentally or theoretically calculated. For example, a storage unit such as the memory of the control unit 122 stores a mold management table for managing the usage log of the mold 106. Therefore, the control unit 122 can determine, by referring to the mold management table, whether the mold 106 is an unused mold or a mold which has not been used for a period longer than the predetermined period T.

In step S1110, it is determined whether the separating force P measured in the preparation operation in step S1106 is equal to or less than the second threshold (that is, the threshold TH4). If the separating force P is not equal to or less than the threshold TH4, that is, is larger than the threshold TH4, the process shifts to step S1120. If the separating force P is equal to or less than the threshold TH4, the process shifts to step S1112.

In step S1112, it is determined whether the amount of change Ci obtained in the preparation processing in step S1106 is equal to or less than the first threshold (that is, is equal to or less than the threshold TH1). If the amount of change Ci is equal to or less than the threshold TH1, since it is thought that the holding surface 104a of the mold stage 104 is in uniform contact with the mold 106, and the surfactant uniformly adheres to the pattern surface 106a, the process shifts to step S1114 to terminate the preparation processing. Note that since steps S1114 to S1118 shown in FIG. 11 are the same as steps S610 to S614 shown in FIG. 6, a detailed description of them will be omitted. In contrast, if the amount of change Ci is not equal to or less than the threshold TH1, that is, is larger than the threshold TH1, the process shifts to step S1120.

In step S1120, it is determined whether the number of times (the number of times of impression) N the mold 106 is pressed against the resin RS on the substrate ST is equal to or less than the specified number of times TH2 and is equal to or less than the specified number of times TH5 in preparation operation in step S1106. If the number of times N of impression is equal to or less than the specified number of times TH2 and is equal to or less than the specified number of times TH5, the process shifts to step S1106 to continue the preparation processing. In addition, if the number of times N of impression exceeds at least one of the specified numbers of times TH2 and TH5, the process shifts to step S1122.

In step S1122, the operator unloads the substrate for preparation processing from the imprint apparatus 100, and terminates the preparation processing. In step S1124, the operator unloads the mold stage 104 and the mold 106 from the imprint apparatus 100. If the number of times N of impression is equal to or less than the specified number of times TH2, it is not necessary to unload the mold stage 104 from the imprint apparatus 100 in step S1124.

In step S1126, the apparatus inspects the resin RS on the substrate for preparation operation which is unloaded in step S1122 and the mold stage 104 and the mold 106 unloaded in step S1124. If the number of times N of impression is equal to or less than the specified number of times TH2, it is not necessary to inspect the mold stage 104 in step S1124. Likewise, if the number of times N of impression is equal to or less than the specified number of times TH5, it is not necessary to inspect the resin RS in step S1124. Subsequently, predetermined processing (for example, replacement of the resin RS, the mold stage 104, and the mold 106) is performed in accordance with the inspection results on the resin RS, the mold stage 104, and the mold 106, and the process shifts to step S1104.

As described above, this embodiment can make a surfactant come into uniform contact with the pattern surface 106a of the mold 106 as well as making the mold 106 come into uniform contact with the holding surface 104a of the mold stage 104. The imprint apparatus 100 according to this embodiment can therefore accurately transfer the pattern of the mold 106 to a target position on the substrate ST without generating any defective pattern portion.

Note that conditions for mold pressing operation in preparation processing or adhesion processing may differ from conditions for mold pressing operation in imprint processing to be performed afterward. For example, the time for pressing a mold in preparation processing or adhesion processing may be longer than the time for pressing a mold in imprint processing. In addition, the pressing force on a mold in preparation processing or adhesion processing may be larger than the pressing force on a mold in imprint processing. Furthermore, it is possible to relatively vibrate a mold and a substrate in preparation processing or adhesion processing. This makes it possible to decrease the number of times of pressing a mold which is required to make the mold come into uniform contact with the holding surface of the mold stage and the number of times of pressing a mold which is required to make a surfactant adhere to a pattern surface.

The above description has exemplified, as the pressing operation of pressing the mold 106 against the holding surface 104a of the mold stage 104, the operation of pressing the mold 106 against the resin RS supplied onto the substrate ST. However, it is also possible to perform the pressing operation of pressing the mold 106 against the holding surface 104a of the mold stage 104 by using the adjustment units 116 arranged around the mold 106 (see FIG. 2).

More specifically, in preparation processing, first of all, when the operator loads the mold 106 into the imprint apparatus 100 and makes the holding surface 104a of the mold stage 104 hold the mold 106, the measurement unit 118 measures the position of the mold 106 on the holding surface 104a. The apparatus then performs the pressing operation of pressing the mold 106 against the holding surface 104a of the mold stage 104 by causing the adjustment units 116 to change the attitude of the mold 106 by applying force to a side surface of the mold 106. The apparatus obtains an amount of change Cm in the position of the mold 106 after the adjustment units 116 apply force to a side surface of the mold 106 (that is, after the pressing operation) relative to the position of the mold 106 before the adjustment units 116 apply force to the side surface of the mold 106 (that is, before the pressing operation).

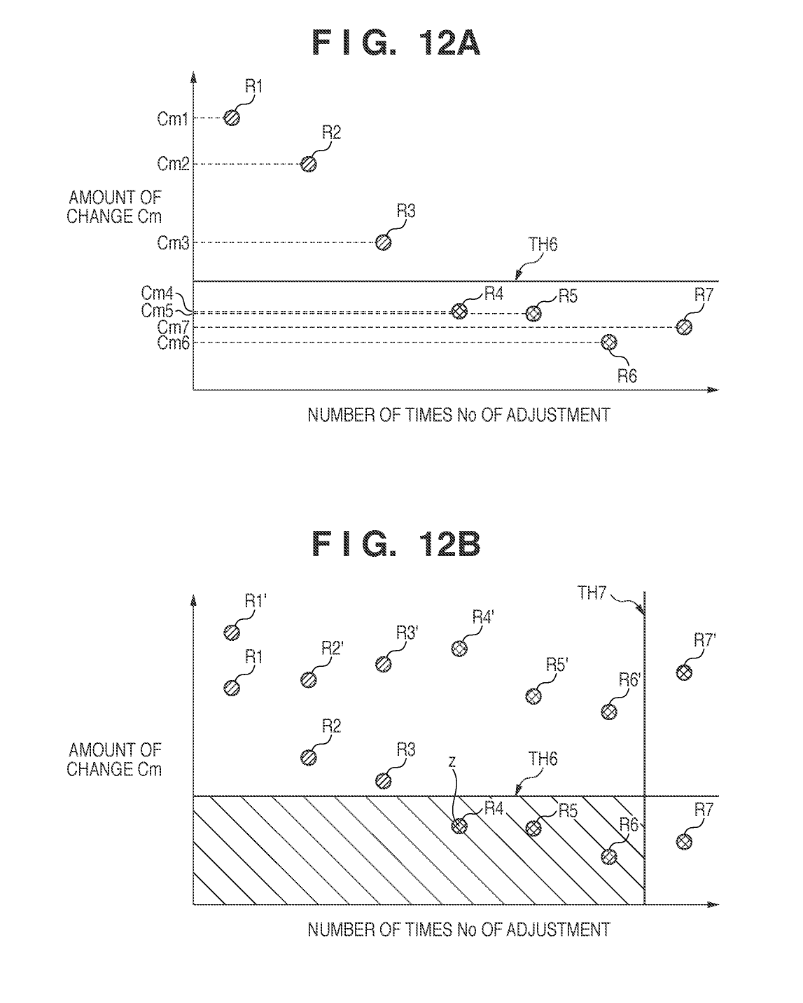

FIG. 12A is a graph showing the relationship between a number of times (a number of times of impression) No the adjustment units 116 apply force to a side surface of the mold 106 and the amount of change Cm in the position of the mold 106 on the holding surface 104a of the mold stage 104. An amount of change Cm1 corresponding to the plot R1 indicates the amount of change in the position of the mold 106 when force is applied to a side surface of the mold 106 once (No=1) relative to the position of the mold 106 when no force is applied to a side surface of the mold 106 (No=0). In this case, since the holding surface 104a of the mold stage 104 is not in uniform contact with the mold 106, the amount of change Cm1 is larger than a threshold TH6. Note that the threshold TH6 is set to a value equal to or less than the maximum value of the amount of change Cm for the transfer of a pattern to a target position on the substrate (that is, a value including a predetermined margin relative to the maximum value), and is an experimentally or theoretically derived value.

Applying force to a side surface of the mold 106 repeatedly (a plurality of number of times) will gradually bring the mold 106 into uniform contact with the holding surface 104a of the mold stage 104. Therefore, as indicated by plots R2, R3, and R4, the amount of change Cm gradually decreases to amounts of change Cm2, Cm3, and Cm4. When the mold 106 comes into uniform contact with the holding surface 104a of the mold stage 104, the amount of change Cm converges (becomes values near amounts of change Cm5, Cm6, and Cm7), as indicated by plots R5, R6, and R7.

As indicated by inequality (5), it is thought that when the amount of change Cm is equal to or less than the threshold TH6 (the amounts of change Cm4 to Cm7), the holding surface 104a of the mold stage 104 is in uniform contact with the mold 106. It is therefore possible to transfer the pattern of the mold 106 to the target position on the substrate without any positional shift of the mold 106 due to the impressing force generated when the mold 106 is pressed against the resin RS.

Cm≦TH6 (5)

Note that in preparation processing, even if the number of times the mold 106 is pressed against the holding surface 104a of the mold stage 104, that is, force is applied to a side surface of the mold 106, becomes equal to or more than a specified number of times, the amount of change Cm may not become equal to or less than the threshold TH6. FIG. 12B is a graph showing the relationship between the number of times (the number of times of adjustment) No the adjustment units 116 apply force to a side surface of the mold 106 and the amount of change Cm in the position of the mold 106 on the holding surface 104a of the mold stage 104. Referring to FIG. 12B, plots R1 to R7 indicate that the amount of change Cm becomes equal to or less than TH6 before the number of times No of adjustment reaches a specified number of times TH7. In contrast, plots R1′ to R7′ indicate that even when the number of times No of adjustment becomes equal to or more than the specified number of times TH7, the amount of change Cm does not become equal to or less than the threshold TH6. In this case, since the mold stage 104 and the mold 106 may not be in a normal state, it is necessary to terminate the preparation processing and inspect the mold stage 104 and the mold 106 and to replace the mold stage 104 and the mold 106 in accordance with the inspection results. The apparatus then performs imprint processing upon confirming that the relationship between the amount of change Cm and the threshold TH6 and the relationship between the number of times No of adjustment and the specified number of times TH7 satisfy inequalities (6):

Cm≦TH6 and No≦TH7 (6)

A manufacturing method of devices (such as a semiconductor integrated circuit element and a liquid crystal display element) as commodities includes a step of transferring (forming) a pattern on a substrate (such as a wafer, a glass plate, and a film substrate) using the imprint apparatus 100. The manufacturing method further includes a step of etching the substrate with the transferred pattern. In place of the etching step, the manufacturing method includes another processing step of processing the substrate with the transferred pattern to manufacture other commodities, such as pattern dot media (recording media) and optical elements.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent application No. 2010-101441 filed on Apr. 26, 2010, which is hereby incorporated by reference herein in its entirety.

What is claimed is:

1. An imprint apparatus which performs imprint processing of curing a resin on a substrate while pressing a mold against the resin, and transferring a pattern onto the substrate by separating the mold from the cured resin, the apparatus comprising:
a holding unit including a holding surface which comes into contact with the mold and configured to hold the mold on the holding surface;
a measurement unit configured to measure a position of the mold on the holding surface; and
a processing unit configured to perform preparation processing including at least one pressing operation of stabilizing the position of the mold on the holding surface by pressing the mold against the holding surface before the imprint processing,
wherein said processing unit repeats the pressing operation in the preparation processing if an amount of change in the position of the mold after the pressing operation, which is measured by said measurement unit, relative to the position of the mold before the pressing operation exceeds a first threshold, and terminates the preparation processing if the amount of change is not more than the first threshold.

2. The apparatus according to claim 1, further comprising a driving unit configured to drive the mold,
wherein said processing unit performs the pressing operation by causing said driving unit to press the mold against a resin supplied onto the substrate for the preparation processing.

3. The apparatus according to claim 1, wherein said measurement unit includes interferometers arranged around the mold.

4. The apparatus according to claim 2, wherein the preparation processing includes at least two times of the pressing operation including a first pressing operation and a second pressing operation,
said measurement unit includes a detection optical system configured to detect a mark formed on the substrate and a pattern of the mold transferred onto the substrate by curing a resin supplied onto the substrate while pressing the mold against the resin, and separating the mold from the cured resin, for the preparation processing, and
an amount of change in the position of the mold after the second pressing operation relative to the position of the mold before the second pressing operation is obtained from a positional relationship between the mark after the first pressing operation, which is detected by the detection optical system, and the pattern of the mold which is transferred onto the substrate, and a positional relationship between the mark after the second pressing operation, which is detected by the detection optical system, and the pattern of the mold which is transferred onto the substrate.

5. The apparatus according to claim 1, wherein said processing unit performs the preparation processing by using a substrate for preparation processing which differs from the substrate for which the imprint processing is performed.

6. The apparatus according to claim 1, further comprising an adjustment unit configured to adjust a magnification and distortion of the mold by applying force to a side surface of the mold when performing the imprint processing, and
said processing unit performs the pressing operation by changing an attitude of the mold by causing said adjustment unit to apply force to a side surface of the mold in the preparation processing.

7. The apparatus according to claim 1, wherein said processing unit terminates the preparation processing if the number of times of the pressing operation becomes not less than a specified number of times.

8. The apparatus according to claim 1, further comprising:
a driving unit configured to drive the mold; and
a detection unit configured to detect a separating force required to separate the mold from the cured resin on the substrate,
wherein said processing unit performs adhesion processing including at least one adhesion operation of making a surfactant supplied onto the substrate adhere to a pattern surface of the mold, before the imprint processing, by causing said driving unit to press the mold against a resin containing the surfactant, curing the resin, and separating the mold from the cured resin, and
said processing unit repeatedly performs the adhesion operation if the separating force detected by said detection unit exceeds a second threshold in the adhesion processing, and terminates the adhesion processing if the separating force detected by said detection unit is not more than the second threshold in the adhesion processing.

9. The apparatus according to claim 1, wherein a resin supplied onto a substrate for preparation processing contains a surfactant, and
said processing unit performs the pressing operation and adhesion operation of making the surfactant adhere to a pattern surface of the mold by causing said driving unit to press the mold against a resin containing the surfactant which is supplied onto the substrate for the preparation processing.

10. A manufacturing method of commodities comprising:
a step of using an imprint apparatus to form a pattern of a resin on a substrate; and
a step of processing the substrate with the pattern,
wherein the imprint apparatus which performs imprint processing of curing a resin on the substrate while pressing a mold against the resin, and transferring a pattern onto the substrate by separating the mold from the cured resin, the imprint apparatus including:
a holding unit including a holding surface which comes into contact with the mold and configured to hold the mold on the holding surface;
a measurement unit configured to measure a position of the mold on the holding surface; and
a processing unit configured to perform preparation processing including at least one pressing operation of stabilizing the position of the mold on the holding surface by pressing the mold against the holding surface before the imprint processing,
wherein said processing unit repeats the pressing operation in the preparation processing if an amount of change in the position of the mold after the pressing operation, which is measured by said measurement unit, relative to the position of the mold before the pressing operation exceeds a first threshold, and terminates the preparation processing if the amount of change is not more than the first threshold.
